(19) United States
(12) Patent Application Publication
(10) Pub. No.: US 2005/0169644 A1
(43) Pub. Date: Aug. 4, 2005

(54) Optical signal transmitting device

(75) Inventors: Osamu Ueno, Ashigarakami-gun (JP); Masaaki Miura, Minato-ku (JP); Kenji Matsumoto, Ashigarakami-gun (JP); Hiroyuki Hiiro, Ashigarakami-gun (JP)

Correspondence Address: OLIFF & BERRIDGE, PLC, P.O. BOX 19928, ALEXANDRIA, VA, 22320, US

(73) Assignees: FUJI XEROX CO., LTD., MINATO-KU (JP); FUJI PHOTO FILM CO., LTD., MINAMI-ASHIGARA-SHI (JP)

(21) Appl. No.: 10/954,208

(22) Filed: Oct. 1, 2004

(30) Foreign Application Priority Data
Nov. 14, 2003 (JP) 2003-385495

(51) Int. Cl. H04B 10/04

(52) U.S. Cl. 398/201

(57) ABSTRACT

An optical signal transmitting device includes: a semiconductor laser diode that is disposed so that its periphery is covered by a laser package and which emits laser light in accordance with information to be transmitted; and a light limiting member that covers at least part of the periphery of the semiconductor laser diode and limits the light amount and divergence angle of the laser light emitted from the semiconductor laser diode. An opening is formed in a side wall of the light limiting member, and the laser light whose light amount and divergence angle have been limited by the light limiting member is guided to optical fiber connected to an optical signal device.

### CROSS-REFERENCE TO RELATED APPLICATION

This application claims priority under 35 USC 119 from Japanese Patent Application No. 2003-385495, the disclosure of which is incorporated by reference herein.

### BACKGROUND OF THE INVENTION

1. Field of the Invention

The present invention relates to an optical signal transmitting device for transmitting optical signals.

2. Description of the Related Art

Conventionally, in small-scale networks such as so-called home networks, the utilization of acrylic (e.g., polymethyl methacrylate; abbreviated as PMMA below) plastic optical fiber (POF) for optical fiber serving as a transmission line has been expected because it is safe and inexpensive. Usually, with acrylic POF, there is little light loss with respect to visible light with a wavelength of 680 nm or less, but high-speed modulation of a Gbps band cannot be done with a visible-light light source. For example, a light emitting diode (LED) is widely used as such a visible-light light source, but the frequency band is generally about 100 MHz and cannot accommodate high-speed modulation.

In Japanese Patent Application Laid-Open Publication (JP-A) No. 2002-64433, a light-emitting element drive circuit where the S/N ratio of signals after transmission is excellent has been proposed as a method of conducting signal transmission at a faster speed, but there is a limit on high-speed modulation.

Semiconductor laser diodes (LD) are known as light sources capable of high-speed modulation, but laser light having a wavelength in the visible light region can normally be modulated to several hundred Mbps at most, and high-speed modulation of a Gbps band has been difficult. A method of raising the light output of a semiconductor laser diode to stabilize the waveform is conceivable, but because high safety is particularly demanded for uses such as in home networks, it is necessary to use a high-output semiconductor laser diode and implement safety measures to ensure that laser safety standards are met, which leads to an increase in cost.

Even when a light source capable of high-speed modulation is used, with graded index plastic optical fiber (GI-POF) suited for high-speed modulation, there is the drawback that loss at the optically coupled portion (end portion at which the laser light is made incident) is relatively large. For example, JP-A No. 11-119006 discloses a technique for ensuring safety by coating part of a light transmitting module with a film having the dual functions of attenuating transmitted light and preventing reflected light. However, even with the technique disclosed in that document, optical coupling efficiency cannot be raised because the incident angle at the optically coupled portion of the GI-POF cannot be adjusted.

### SUMMARY OF THE INVENTION

According to the present invention, there is provided an optical signal transmitting device with which safety is ensured and high-speed modulation is possible, and whose optical coupling efficiency with respect to optical fiber is high.

An optical signal transmitting device of a first aspect of the invention includes: a semiconductor laser diode that emits laser light in accordance with information to be transmitted; and a light limiting member that limits the light amount and divergence angle of the laser light emitted from the semiconductor laser diode.

An optical signal transmitting device of another aspect of the invention includes: a semiconductor laser diode that is disposed so that its periphery is covered and which emits laser light in accordance with information to be transmitted; and a light limiting member that covers at least part of the periphery of the semiconductor laser diode and limits the light amount and divergence angle of the laser light emitted from the semiconductor laser diode, wherein the laser light whose light amount and divergence angle have been limited by the light limiting member is guided to optical fiber to be connected to an optical signal device.

In this optical signal transmitting device, the light amount and divergence angle of the laser light emitted from the semiconductor laser diode are simultaneously limited by the light limiting member. By limiting the light amount of the laser light, the light amount of laser light leaking to the outside can be reduced and lowered to a light amount that is safe in terms of laser use. Moreover, high-speed modulation becomes possible because a high-output semiconductor laser diode whose relaxation oscillation frequency is high can be used as the semiconductor laser diode.

Also, by limiting the divergence angle of the laser light, the optical coupling efficiency at the optically coupled portion can be maintained at a high level because the angle of incidence at the optical fiber can be made smaller.

Due to the above-described configurations of the invention, safety is ensured, high-speed modulation is possible and the optical coupling efficiency with respect to optical fiber becomes higher.

### BRIEF DESCRIPTION OF THE DRAWINGS

Preferred embodiments of the present invention will be described in detail based on the following figures, wherein:

FIGS. 1A and 1B are diagrams showing part of an optical fiber cable, to which an optical signal transmitting device pertaining to a first embodiment of the invention has been applied, in a state where a light transmitting plug is separated from a device receptacle, with FIG. 1A being a horizontal sectional view and FIG. 1B being a longitudinal sectional view;

FIG. 2 is a cross-sectional view of the optical signal transmitting device of the first embodiment of the invention;

FIG. 3 is a graph showing the relationship between the light output of an LD element and relaxation oscillation frequency;

FIG. 4 is a cross-sectional view of an optical signal transmitting device of a second embodiment of the invention;

FIG. 5 is a cross-sectional view of an optical signal transmitting device of a third embodiment of the invention; and

FIG. 6 is a cross-sectional view of an optical signal transmitting device of a fourth embodiment of the invention.

### DETAILED DESCRIPTION OF THE INVENTION

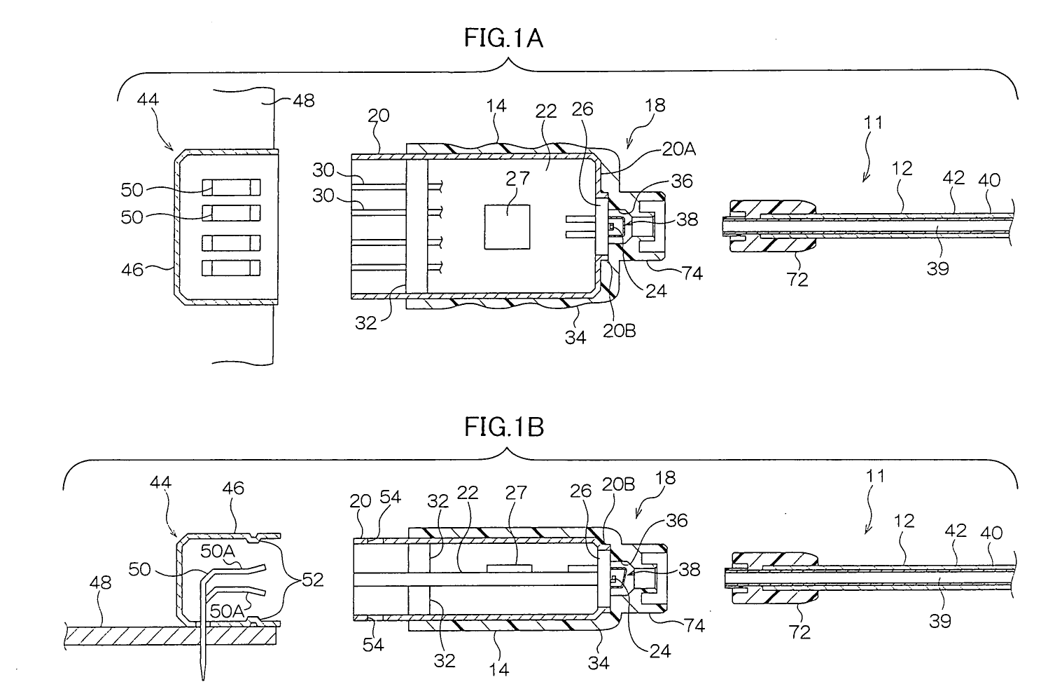

FIGS. 1A and 1B are partial views of an optical fiber cable 11 of an optical signal transmission system to which an optical signal transmitting device 18 pertaining to a first embodiment of the invention has been applied. The optical signal transmission system is used for transmitting optical signals between an external transmitting device and an external receiving device (neither is illustrated).

The optical fiber cable 11 is configured by an optical cable body 12, a light transmitting plug 14 at one end of the optical cable body 12, and a light receiving plug (not illustrated) at the other end. A connector member 72 is attached to one end of the optical cable body 12, and the optical fiber cable 11 is connected to the light transmitting plug 14 by fitting the connector member 72 into a connector member 74 of the light transmitting plug 14. Thus, the optical cable body 12 is attachable to and detachable from the light transmitting plug 14.

The light transmitting plug 14 is disposed with a plug shield case 20 that has a substantially rectangular parallelepiped shape and includes an open end.

The plug shield case 20 is formed by, for example, a common machining process such as folding, rolling and welding a metal plate. The plug shield case 20 can also be formed by deep-drawing a single metal plate.

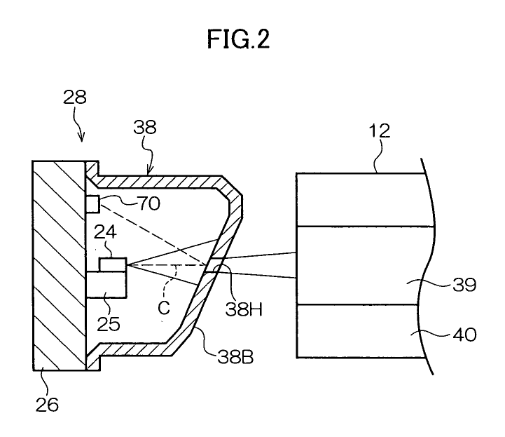

A rectangular transmission-use circuit board 22 is inserted through the open portion into the plug shield case 20. A laser package 28 is fixed to one end of the transmission-use circuit board 22. The laser package 28 is configured by a discoid mount 26, a semiconductor laser diode 24 attached to the mount 26 via an attachment member 25 (see FIG. 2), and a later-described light limiting member 38 that doubles as a cap for the laser package 28. The semiconductor laser diode 24 in the present embodiment functions as a light-emitting element and emits laser light in accordance with information to be transmitted. The semiconductor laser diode 24 and the mount 26 are electrically insulated.

A transmission circuit comprising various electrical parts (not illustrated) such as an IC 27 that drives the semiconductor laser diode 24 is mounted on the transmission-use circuit board 22. Patterns 30 connected to the transmission circuit extend towards the end portion of the transmission-use circuit board 22 at the side opposite from the light-emitting element side.

A short cylindrical portion 20B is formed in the center of a wall surface 20A of the plug shield case 20 at the side opposite from the open side, and the mount 26 is press-fitted into the cylindrical portion 20B.

Two spacers 32 are attached to both surfaces of the transmission-use circuit board 22 so that the transmission-use circuit board 22 does not rattle inside the plug shield case 20.

Substantially all of the plug shield case 20, except for a portion at the open side thereof, is covered by an external cover 34 comprising a thermoplastic synthetic resin. The connector member 74, to which the connector member 72 of the optical cable body 12 is fitted, is formed integrally with the external cover 34.

A recess 36 is formed in a portion inside the external cover 34 facing the mount 26, and one end of the attached optical cable body 12 is inserted therein.

A GI-POF 39 is used as optical fiber in the optical fiber body 12 of the present embodiment. The GI-POF 39 is covered by a first cover 40 and a second cover 42. An end surface of the GI-POF 39 is disposed near and facing a front surface of the semiconductor laser diode 24 in a state where the optical fiber cable 11 is connected to the light transmitting plug 14.

FIG. 2 schematically shows the structure of the vicinity of the light limiting member 38 of the optical signal transmitting device 18 of the present embodiment. As shown in detail in FIG. 2, the light limiting member 38 is attached to the mount 26. The light limiting member 38 is formed in a substantial box shape, and the side facing the mount 26 is open. The side opposite from the open surface serves as a limiting wall 38B that is slanted with respect to the mount 26. The periphery of the semiconductor laser diode 24 is covered by the mount 26 and the light limiting member 38, but an open portion 38H is formed in the limiting wall 38B so that the open portion 38H is positioned on a line (optical axis C) that connects the centers of the semiconductor laser diode 24 and the GI-POF 39. Laser light emitted from the semiconductor laser diode 24 reaches the GI-POF 39 only through the open portion 38H. The open portion 38H is of a size that allows laser light to pass therethrough at an angle narrower than the divergence angle of the emitted laser light, so that the light amount and divergence angle of the laser light are simultaneously limited. Due to the fact that the divergence angle of the laser light is limited, the incident angle when the laser light is made incident at the end portion of the GI-POF 39 is also limited.

The limiting wall 38B is slanted at an angle that is not orthogonal to the optical axis C of the laser light. Thus, the laser light not transmitted through the open portion 38H strikes the limiting wall 38B and some of that laser light is reflected, but the reflected laser light is not made incident at the semiconductor laser diode 24.

Here, in the present embodiment, the oscillation wavelength of the semiconductor laser diode 24 is visible light of 680 nm or less in order to reduce light loss in the acrylic GI-POF 39. Also, the oscillation light amount of the semiconductor laser diode 24 is adjusted as described later so that the relaxation oscillation frequency (Hz) becomes equal to or greater than the transmission speed (bps) of the optical signals, whereby high-speed modulation can be done more reliably.

A light amount sensor 70 is attached to the mount 26 and can detect the light amount of the laser light reflected by the limiting wall 38B of the light limiting member 38. The intensity of the laser light is monitored with information from the light amount sensor 70 so that the output of the semiconductor laser diode 24 can be precisely controlled. Although the position at which the light amount sensor 70 is attached in FIG. 2 is a position at which the intensity of the laser light reflected by the limiting wall 38B is strongest, the position of the light amount sensor 70 is not limited to this as long as the light amount sensor 70 can reliably detect the light amount. It is of course alright if, as has conventionally been the case, light amount control is conducted so that light leaking from the end surface (left side in FIG. 2) facing the emission end surface of the semiconductor laser diode 24 is monitored with the light amount sensor.

As shown in FIGS. 1A and 1B, a device receptacle 44 is fixed in the vicinity of the surface (outer surface) of the unillustrated external transmitting device and attached to a substrate 48. The light transmitting plug 14 is connected to the device receptacle 44.

The device receptacle 44 is disposed with a device shield case 46, which has a substantially rectangular parallelepiped shape and includes an open end, and connection pins 50.

Similar to the plug shield case 20, the device shield case 46 is formed by, for example, a common machining process such as folding, rolling and welding a metal plate. Also similar to the plug shield case 20, the device shield case 46 can also be formed by deep-drawing a single metal plate.

The connection pins 50 are connected to the substrate 48 by soldering the connection pins 50 to patterns (not illustrated) of the substrate 48.

The connection pins 50 are disposed with pairs of elastic contact portions 50A for contacting the patterns 30 with the transmission-use circuit board 22 of the light transmitting plug 14 sandwiched therebetween.

In the present embodiment, the open portion of the plug shield case 20 is inserted, in a state of substantially tight contact, into the open portion of the device shield case 46, so that the plug shield case 20 is fixed to the device shield case 46.

As shown in FIG. 1B, substantially truncated cone-shaped projections 52 that project inward are pressed in the device shield case 46. In correspondence thereto, round holes 54 are formed in the vicinity of the open portion in the plug shield case 20. When the open portion of the plug shield case 20 is inserted into the open portion of the device shield case 46, the projections 52 slide against the outer peripheral surface of the plug shield case 20 and cause the plug shield case 20 and the device shield case 46 to elastically deform by a slight amount. When the projections 52 reach the round holes 54, the projections 52 are fitted into the round holes 54 and fixed.

Even in the state where the projections 52 are fitted into the round holes 54, the plug shield case 20 and the device shield case 46 are elastically deformed by a slight amount, and a state where the projections 52 pressingly contact open portions of the round holes 54 is maintained.

Also, when the projections 52 are fitted into the round holes 54, the transmission-use circuit board 22 is sandwiched between the contact portions 50A of the connection pins 50 and the contact portions 50A contact the patterns 30 of the transmission-use circuit board 22, whereby electrical connection is conducted.

In the optical signal transmission system pertaining to the present embodiment with the above-described configuration, when optical signals are transmitted between the external transmitting device and the external receiving device, the optical cable body 12 is connected to the light transmitting plug 14, the light transmitting plug 14 is connected to the device receptacle 44 of the external transmitting device and the light receiving plug is connected to a device receptacle of the external receiving device.

Here, when electrical signals are inputted via the connection pins 50 and the patterns 30 to the transmission circuit of the transmission-use circuit board 22, laser light including optical signals is emitted from the semiconductor laser diode 24.

As will be understood from FIG. 2, although the emitted laser light has a predetermined divergence angle, only the light passing through the open portion 38H reaches the GI-POF 39 because the open portion 38H is formed in the light limiting member 38. Namely, the intensity and divergence angle of the laser light are simultaneously limited by the light limiting member 38 in which the open portion 38H is formed.

Here, even if laser light leaks to the outside due to whatever reason, the intensity of the leaking laser light also becomes weak because the intensity and divergence angle of the laser light are limited in the present embodiment. For example, even if the light output of the semiconductor laser diode 24 is sufficiently raised, laser light leaking to the outside can be lowered to a light amount level that is safe in terms of laser use. In other words, safety when laser light leaks to the outside can be reliably ensured, and it becomes possible to raise the light output of the semiconductor laser diode 24 itself to an extent that the affect of relaxation oscillation is reduced.

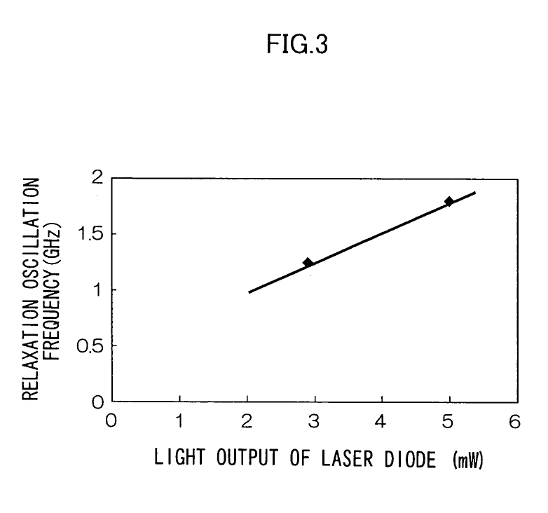

FIG. 3 shows an example of the relationship between the light output of the semiconductor laser diode and the relaxation oscillation frequency. As will be understood from the graph, the relaxation oscillation frequency becomes higher as the light output of the semiconductor laser diode becomes larger. For example, when the light output of the semiconductor laser diode is under 3 mW, the relaxation oscillation frequency is also generally under 1.25 GHz, but when the light output of the semiconductor laser diode is at 3 mW or higher, the relaxation oscillation frequency becomes 1.25 GHz or higher and moves to a higher frequency. When the optical signal wavelength was observed when the semiconductor laser diode was modulated by a Gigabit Ethernet (registered trademark) signal (1.25 Gbps), it was understood that an excellent light waveform can be obtained at an output of generally 3 mW or higher. This is thought to be because, as the light output increased, the relaxation oscillation frequency became higher than the frequency band necessary for transmission, and the light waveform became excellent. In this case, as a light output target, it was understood that it is best to raise the light output until the numerical value of the relaxation oscillation frequency (Hz) becomes larger than the numerical value of the data rate (bps) of the modulation signals used.

Usually, with optical fiber such as the GI-POF 39 used in the present embodiment, there is a tendency for the optical coupling efficiency to become higher the smaller that the angle of incidence at the end portion is, and light loss also becomes smaller. In the present embodiment, because the divergence angle of the laser light is limited by the light limiting member 38, the angle of incidence when the laser light is made incident at the GI-POF 39 also becomes smaller. For this reason, the optical coupling efficiency becomes higher and the light loss becomes smaller.

In this manner, the laser light made incident at the GI-POF 39 is transmitted via the GI-POF 39 to the light receiving plug and received by a receiving element.

As described above, in the present embodiment, the light amount and divergence angle of the laser light are simultaneously limited by the light limiting member 38, high-speed modulation is enabled using a high-intensity laser as the semiconductor laser diode 24, and high safety is ensured. Moreover, the angle of incidence of the laser light at the GI-POF 39 is reduced, the optical coupling efficiency is raised and light loss is reduced.

The present invention is not limited to the first embodiment. It is also possible for the invention to have configurations described below in second, third and fourth embodiments. In the second and third embodiments, detailed description will be omitted because the overall configuration of the optical signal transmitting devices is identical to that of the first embodiment.

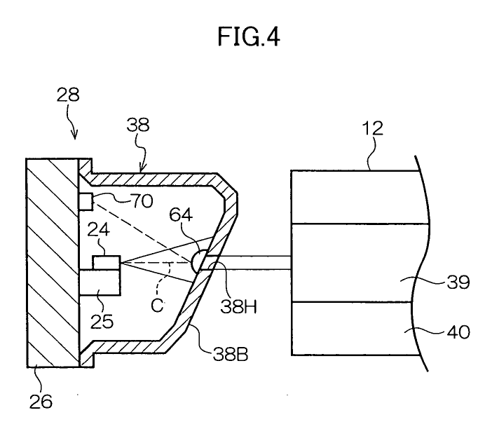

In the second embodiment shown in FIG. 4, similar to the first embodiment, the light limiting member 38 including the open portion 38H is attached to the mount 26, but a lens 64 is attached to a position inside the light limiting member 38 corresponding to the open portion 38H. The lens 64 is configured to refract the laser light so that the laser light is made into substantially parallel light, and is shaped so that the laser light passing through the open portion 38H and reaching the GI-POF 39 is made into substantially parallel light. Thus, the optical coupling efficiency is further made higher and light loss is further made smaller because the angle of incidence at the GI-POF 39 becomes even smaller in comparison to the first embodiment.

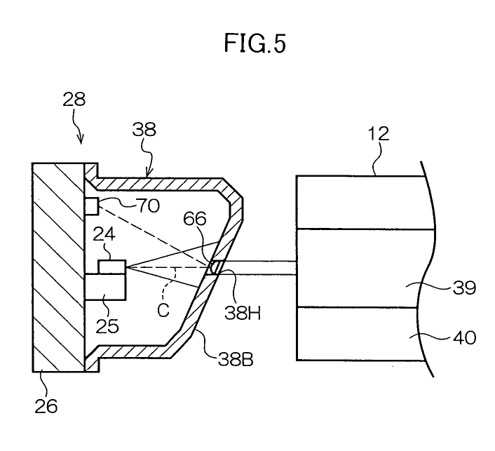

In the third embodiment shown in FIG. 5, a lens 66 that provides the same action as that of the lens 64 of the second embodiment is fixed inside the open portion 38H of the light limiting member 38. Thus, in the third embodiment, the open portion 38H acts to hold the lens 66.

In the third embodiment of this configuration, similar to the second embodiment, the laser light reaching the GI-POF 39 is made into substantially parallel light. Thus, the optical coupling efficiency is further made higher and light loss is further made smaller because the angle of incidence at the GI-POF 39 becomes even smaller in comparison to the first embodiment.

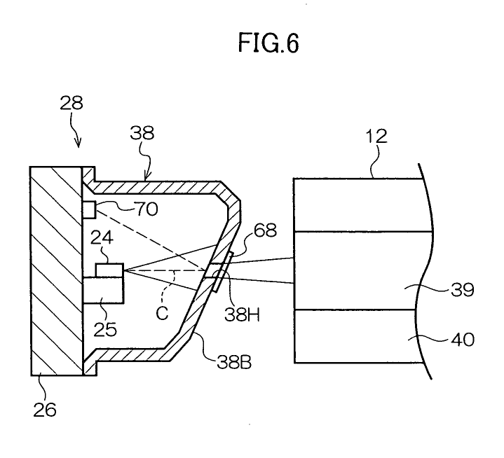

In the fourth embodiment shown in FIG. 6, an attenuation member 68 is attached to the outer side of the light limiting member 38 so as to cover the open portion 38H. The attenuation member 68 is configured by a member that causes the light to be attenuated, such as an ND filter. Only some of the laser light emitted from the semiconductor laser diode 24 passes through the open portion 38H, whereby the intensity and divergence angle are simultaneously limited, but the intensity is further lowered by the attenuation member 68. Thus, it becomes possible to further raise the output of the semiconductor laser diode 24, reliably reduce the light amount and ensure safety.

With respect to the lenses 64 and 66 of the second and third embodiments, the angle of incidence at the GI-POF 39 can be made even smaller than that of the first embodiment. From this standpoint, the lenses 64 and 66 do not have to completely make the laser light into parallel light, but it is most preferable for the lenses 64 and 66 to make the laser light into parallel light. Also, the positions of the lenses 64 and 66 are not particularly limited as long as the lenses 64 and 66 provide the above-described action, but it is preferable to dispose them near the open portion 38H so that the optical signal transmitting device 18 can be prevented from increasing in size.

In the above embodiments, example configurations were described where the limiting wall 38B of the light limiting member 38 was slanted with respect to the optical axis of the light beams, but it is not necessary for the limiting wall 38B to be slanted in this manner as long as it can limit the light amount and divergence angle of the light beams. However, it is preferable to slant the limiting wall 38B as in the above embodiments because the light beams reflected at the periphery of the open portion 38H are not made incident at the semiconductor laser diode 24.

The configuration of the limiting wall 38B that prevents light beams reflected at the periphery of the open portion 38H from being made incident at the semiconductor laser diode 24 is not limited to the above. For example, an absorbing portion (e.g., a reflection-preventing coat) that suppresses the reflection of light beams may be disposed at the periphery of the open portion 38H (at least the region where the light beams strike), or a refracting portion (e.g., a lens or mirror) that refracts the light beams in a direction other than that of the semiconductor laser diode 24 may be disposed at the periphery of the open portion 38H (at least the region where the light beams strike).

Although it is possible to list various example configurations that prevent the light beams from inadvertently being made incident at the semiconductor laser diode 24, reflected light of the laser light is still present inside the light limiting member 38 in each configuration. Thus, it is preferable to dispose the light amount sensor 70 shown in FIGS. 2, 4, 5 and 6 so that the output of the semiconductor laser diode 24 can be precisely controlled.

It is not necessary for the light limiting member 38 to double as a cap for the laser package 28, but by configuring the limiting member 38 so that it doubles as a cap, the cost of the device becomes less expensive because the number of parts is reduced.

In the above embodiments, an example was described where one open portion 38H was formed, but it is not necessary for there to be only one open portion 38H. There may also be plural open portions 38H. However, it is preferable to form only one open portion 38H, because the structure of the light limiting member 38 becomes simple and molding and processing become easy.

Also, in the above embodiments, one light-emitting element (semiconductor laser diode) was disposed in the light transmitting plug 14, but the invention is not limited thereto. Light-emitting elements or light-receiving elements may be plurally disposed and connected to plural optical cable bodies.

The invention has been described above in regard to specific embodiments, but the invention should not be interpreted as being limited to these specific examples.

In one aspect of the invention, the optical signal transmitting device is disposed with a semiconductor laser diode that emits laser light in accordance with information to be transmitted and a light limiting member that limits the light amount and divergence angle of the laser light emitted from the semiconductor laser diode.

In this aspect, the optical signal transmitting device can include a light converting member that converts the laser light emitted from the semiconductor laser diode into parallel light.

By making the laser light into parallel light with the light converting member, the optical coupling efficiency at the optically coupled portion can be further raised.

The light converting member may be disposed either in front of or behind the light limiting member, but it is preferable for the light converting member to be disposed at a position where it limits at least the divergence angle of the laser light, so that the optical signal transmitting device can be prevented from increasing in size.

Also, the oscillation light amount of the semiconductor laser diode may be set so that it has a relaxation oscillation frequency equal to or greater than the transmission speed of the optical signals.

By setting the oscillation light amount of the semiconductor laser diode in this manner, it becomes possible to reliably modulate the light at a high speed.

Also, the semiconductor laser diode may be configured to emit visible light with a wavelength of 680 nm or less.

Thus, light loss in a case where POF is used is made smaller and the optical signal transmitting device becomes suitable for POF use.

Also, the light limiting member may be disposed with at least one open portion that allows only some of the laser light emitted from the semiconductor laser diode to pass therethrough.

In this manner, the light amount and divergence angle of the laser light can be reliably limited with a simply configuration disposed with the light limiting member including the open portion. The invention may also be configured, using reflection, absorption or refraction, so that the laser light does not leak to the outside at portions other than the open portion.

The light limiting member may also be disposed with a slanted surface that is not orthogonal to the optical axis of the laser light emitted from the semiconductor laser diode.

By configuring the light limiting member in this manner, the affect of so-called return light can be reduced because the laser light reflected at the slanted surface does not reach the semiconductor laser diode.

The optical signal transmitting device may further include attenuating member to cause the laser light emitted from the semiconductor laser diode to be attenuated.

Thus, the output of the semiconductor laser diode can be further raised and high safety can be ensured because the light amount can be further reduced by the attenuating member with respect to the laser light whose light amount and divergence angle are limited by the light limiting member.

The light limiting member can also double as at least a portion of a package covering the semiconductor laser diode.

Thus, it becomes possible to reduce the number of parts and configure the optical signal transmitting device at a low cost.

A light detector that detects the laser light emitted from the semiconductor laser diode may also be disposed.

By detecting the laser light with the light detector, the light amount of the laser light can be precisely monitored and adjusted.

### EXAMPLE

In this example, the laser light is emitted under the following conditions and transmitted by the GI-POF 39 in the optical signal transmitting device 18 of the first embodiment.
Type of semiconductor laser diode: end-surface emitting semiconductor laser diode
Output of semiconductor laser diode: 4.4 mW
Divergence angle of laser beam from semiconductor laser diode: maximum of 30°
Wavelength of laser beam: 650 nm
Divergence angle after passing through light limiting member: about 7°

As a result, in the present example, the affect of relaxation oscillation is reduced, high-speed modulation at 1.25 Gbps is possible, and leakage of the light beams to the outside can be kept within a sufficient safe range. Moreover, the optical coupling efficiency becomes high and the light loss becomes small because the angle of incidence when the laser beam is made incident at the GI-POF 39 becomes about 7°, which is narrow. The intensity of the light after the light has passed through the light limiting member is about 0.3 mW, so that light output is obtained with no problems in terms of laser safety.

1. An optical signal transmitting device comprising:
a semiconductor laser diode that emits laser light in accordance with information to be transmitted; and
a light limiting member that limits the light amount and divergence angle of the laser light emitted from the semiconductor laser diode.

2. The optical signal transmitting device of claim 1, further comprising a light converting member that converts the laser light emitted from the semiconductor laser diode into substantially parallel light.

3. The optical signal transmitting device of claim 2, wherein the light converting member includes a lens that refracts the laser light so that the laser light is made into substantially parallel light.

4. The optical signal transmitting device of claim 1, wherein a light output amount of the semiconductor laser diode is set so that it has a relaxation oscillation frequency equal to or greater than a transmission speed of optical signals.

5. The optical signal transmitting device of claim 1, wherein the semiconductor laser diode emits visible light with a wavelength of 680 nm or less.

6. The optical signal transmitting device of claim 1, wherein the light limiting member is disposed with at least one open portion that allows some of the laser light emitted from the semiconductor laser diode to be passed therethrough.

7. The optical signal transmitting device of claim 6, wherein the light limiting member is disposed with a slanted surface that is not orthogonal to the optical axis of the laser light emitted from the semiconductor laser diode, and the at least one open portion is formed in the slanted surface.

8. The optical signal transmitting device of claim 1, further comprising an attenuating member that causes the laser light emitted from the semiconductor laser diode to be attenuated.

9. The optical signal transmitting device of claim 1, further comprising a package that covers the semiconductor laser diode, wherein the light limiting member forms part of the package.

10. The optical signal transmitting device of claim 1, further comprising a light detector for detecting the laser light emitted from the semiconductor laser diode.

11. An optical signal transmitting device comprising:
a semiconductor laser diode that is disposed so that its periphery is covered and which emits laser light in accordance with information to be transmitted; and
a light limiting member that covers at least part of the periphery of the semiconductor laser diode and limits the light amount and divergence angle of the laser light emitted from the semiconductor laser diode,
wherein the laser light whose light amount and divergence angle have been limited by the light limiting member is guided to optical fiber to be connected to an optical signal device.

12. The optical signal transmitting device of claim 11, wherein the light limiting member includes a wall surface that receives the laser light, and at least one opening that allows the laser light to be transmitted therethrough is disposed in the wall surface.

13. The optical signal transmitting device of claim 12, wherein the at least one opening has a size that allows the laser light to be transmitted therethrough at an angle smaller than the divergence angle of the laser light.

14. The optical signal transmitting device of claim 12, wherein the wall surface is slanted with respect to the optical axis of the laser light emitted from the semiconductor laser diode and the wall surface is not orthogonal to the optical axis.

15. The optical signal transmitting device of claim 12, further comprising a light converting member that shapes the laser light emitted from the semiconductor laser diode into substantially parallel light.

16. The optical signal transmitting device of claim 15, wherein the light converting member includes a lens disposed at the at least one opening in the wall surface.

17. The optical signal transmitting device of claim 11, further comprising an attenuating member that causes the laser light emitted from the semiconductor laser diode to be attenuated.

18. The optical signal transmitting device of claim 11, further comprising a package that covers the semiconductor laser diode, wherein the light limiting member forms at least part of the package.

19. The optical signal transmitting device of claim 11, wherein an oscillation light amount of the semiconductor laser diode is set so that it has a relaxation oscillation frequency equal to or greater than a transmission speed of optical signals.

20. The optical signal transmitting device of claim 11, wherein the semiconductor laser diode emits visible light with a wavelength of 680 nm or less.
